(19) United States
(12) Patent Application Publication
(10) Pub. No.: US 2008/0231903 A1
(43) Pub. Date: Sep. 25, 2008

(54) IMAGE PROCESSING APPARATUS AND CONTROL METHOD THEREOF

(75) Inventors: Reiji Misawa, Tokyo (JP); Osamu Iinuma, Machida-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 12/051,489

(22) Filed: Mar. 19, 2008

(30) Foreign Application Priority Data
Mar. 23, 2007 (JP) 2007-077158

(51) Int. Cl. H04N 1/40

(52) U.S. Cl. 358/2.1; 358/1.9

(57) ABSTRACT

In order to allow to store image data in a color reproducible format while reducing the data size, an image processing apparatus includes an image input unit which inputs image data by reading an original image, a determination unit which determines a representative color included in the image data, a binary image data generation unit which generates binary image data including no color information based on the image data, an additional data generation unit which generates additional data as color information corresponding to each pixel which forms the binary image data based on the representative color determined by the determination unit, and a storage unit which stores the binary image data and the additional data.

### BACKGROUND OF THE INVENTION

1. Field of the Invention

The present invention relates to an image processing technique and, more particularly, to a technique for converting image data into binary image data or grayscale image data whose color information can be restored.

2. Description of the Related Art

Conventionally, some information processing apparatuses having a copy function have a storage function (to be referred to as a BOX function hereinafter) of storing input image data for the purpose of printing, and a data sending function of sending image data to an external information processing apparatus. Note that the image data is data read by a reader, or data (to be referred to as PDL data hereinafter) sent from a host computer, which is connected to the information processing apparatus via a network, via a printer driver.

A BOX function disclosed in Japanese Patent Laid-Open No. 2003-051951 (patent reference 1) stores image data of a color original as monochrome image data or grayscale image data in a BOX, as described in that patent reference. At this time, the monochrome image data can undergo monochrome printing or mono-color printing using a mono color (R/G/B/C/M/Y) designated by the user. Also, the monochrome image data can be sent to an external information processing apparatus as monochrome image data.

However, with the technique of patent reference 1 described above, when an original is a mono-color image, it cannot be automatically color reproduced and printed using that mono color. Likewise, when an original is a two-color image, it cannot be color-reproduced and printed or sent using those two colors. More specifically, in order to color-reproduce the mono-color image or two-color image, the user needs to manually designate a proper color.

When the aforementioned mono-color image or two-color image is stored in a BOX as full color data, it can be automatically color-reproduced and printed or sent using that mono color or two colors. However, since the full color data has a large data size (e.g., 24 bits (=8 bits/color×3)/pixel), a storage area with a large capacity is required to store the data.

### SUMMARY OF THE INVENTION

The present invention has been made in consideration of the aforementioned problems, and has as its object to provide a technique for solving at least one problem.

According to one aspect of the present invention, an image processing apparatus comprises: an image input unit adapted to input image data by reading an original image; a determination unit adapted to determine a representative color included in the image data; a binary image data generation unit adapted to generate binary image data including no color information based on the image data; an additional data generation unit adapted to generate additional data as color information corresponding to each pixel which forms the binary image data based on the representative color determined by the determination unit; and a storage unit adapted to store the binary image data and the additional data.

According to another aspect of the present invention, an image processing apparatus comprises: an image input unit adapted to input image data by reading an original image; a determination unit adapted to determine a representative color included in the image data; a data generation unit adapted to generate data, which includes no color information, and each pixel of which is expressed by an N-bit value (N is a natural number), based on the image data; an additional data generation unit adapted to generate additional data as color information corresponding to each pixel which forms data expressed by the N-bit value based on the representative color determined by the determination unit; and a storage unit adapted to store the data expressed by the N-bit value and the additional data.

According to still another aspect of the present invention, a method of controlling an image processing apparatus, comprises: an image input step of inputting image data by reading an original image; a determination step of determining a representative color included in the image data; a binary image data generation step of generating binary image data including no color information based on the image data; an additional data generation step of generating additional data as color information corresponding to each pixel which forms the binary image data based on the representative color determined in the determination step; and a storage control step of storing the binary image data and the additional data in a storage unit.

According to the present invention, a technique that can store image data in a color-reproducible format while suppressing a data size can be provided.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the concept of reading an original using an MFP, saving data, and outputting the saved data according to the first embodiment;

FIG. 2 is a diagram showing the internal arrangement of an MFP according to the first embodiment;

FIG. 3 is a block diagram showing the software functional arrangement implemented in a controller unit of the MFP according to the first embodiment;

FIGS. 4A to 4C show an example of user interface (UI) windows of the MFP according to the first embodiment;

FIG. 5 is a flowchart executed when the MFP according to the first embodiment performs color determination of an original, and stores image data in a BOX;

FIG. 6 is a flowchart showing the operation associated with monochrome processing in step S506;

FIG. 7 is a flowchart executed upon outputting (printing or sending) monochrome image data saved in the BOX;

FIG. 8 shows data generated by monochrome processing and full color processing;

FIG. 9 is a flowchart showing an example of the processing sequence executed upon ACS determination of read image data;

FIG. 10 shows an example of an original;

FIG. 11 shows an example of a derived color distribution (mono color);

FIG. 12 shows an example of a derived color distribution (two colors); and

FIGS. 13A and 13B show an example of setting windows displayed upon selection of a BOX menu.

### DESCRIPTION OF THE EMBODIMENTS

Preferred embodiments of the present invention will be described in more detail hereinafter with reference to the accompanying drawings. Note that the following embodiments are merely examples, which do not limit the scope of the present invention.

### First Embodiment

A multi-function printer (MFP) with a BOX function will be exemplified below as the first embodiment of an image processing apparatus according to the present invention. Note that terms will be defined as follows based on colors which define an image in the following description.

Monochrome image: a binary image (to be also referred to as a monochrome image hereinafter) defined by two achromatic colors

Mono-color image: a binary image (to be also referred to as a mono-color image hereinafter) defined by only one chromatic color or one chromatic color and white

Two-color image: a binary image defined by one chromatic color and black

Full-color image: a multi-valued image (to be also referred to as a color image hereinafter) defined by three or more colors

<Apparatus Arrangement>

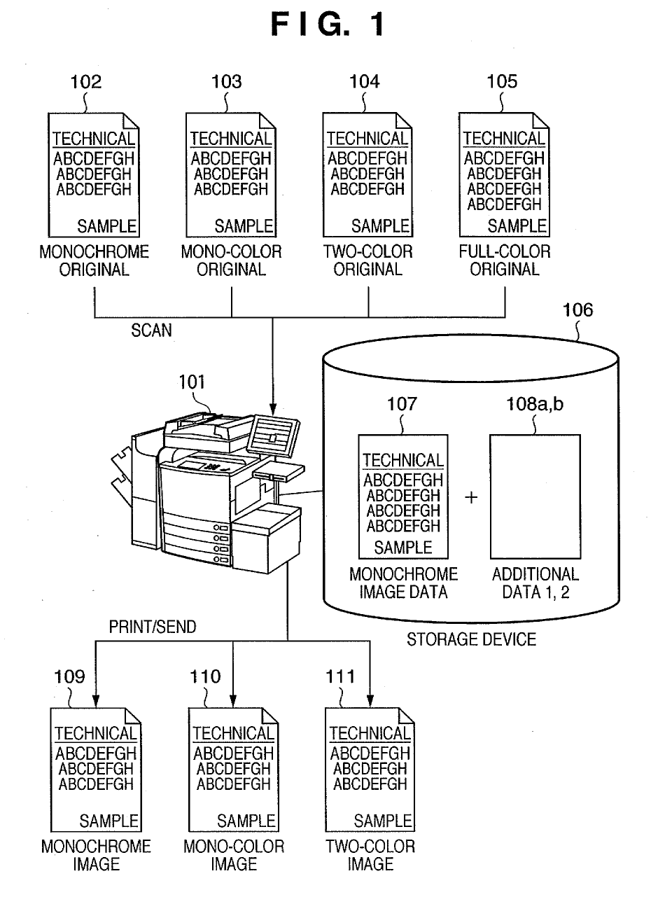

FIG. 1 shows the concept of reading an original using the MFP, saving data, and outputting the saved data according to the first embodiment.

A monochrome original 102, mono-color original 103, two-color original 104, and full-color original 105 are read by a scan function of an MEFP 101. The read images are converted into data by hardware and software groups (to be described later) in the MFP 101, and the converted data are stored as monochrome image data 107 and additional information 108 in a BOX 106. These data are printed or sent as a monochrome image 109, mono-color image 110, and two-color image 111.

Note that “sending” means that image data is converted into data of a general-purpose format (e.g., JPEG, PDF, TIFF, or the like), and the converted data is sent to a host computer connected via a network.

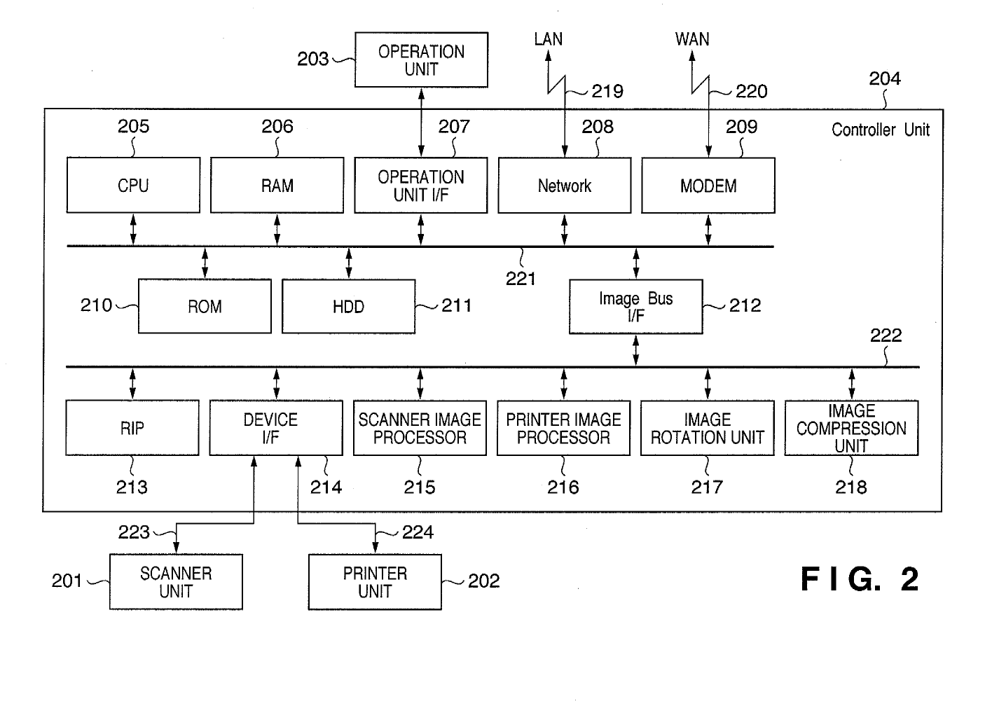

FIG. 2 shows the internal arrangement of the MFP according to the first embodiment.

The MFP 101 comprises a scanner unit 201 as an image input device, and a printer unit 202 as an image output device. The MFP also comprises a controller unit 204 which includes a CPU 205 and respective processors to be described later, and an operation unit 203 as a user interface.

The controller unit 204 is connected to the scanner unit 201, printer unit 202, and operation unit 203. On the other hand, the controller unit 204 is connected to a LAN 219 and a wide area network (WAN) 220 as a general telephone network, thus inputting and outputting image information and device information.

The CPU 205 is a controller which controls the overall system. A RAM 206 is a system work memory required to operate the CPU 205, and is also an image memory used to temporarily store image data. A ROM 210 is a boot ROM, which stores a boot program of the system. An HDD 211 is a hard disk drive, which stores system software and image data. An operation unit I/F 207 is an interface with the operation unit (UI) 203, and which outputs image data to be displayed on the operation unit 203 to it. Also, the I/F 207 transfers information input by the user of this image processing apparatus to the CPU 205. A network 208 connects this image processing apparatus to the LAN 219 to input and output information in a packet format. A modem 209 connects this image processing apparatus to the WAN 220 to demodulate and modulate information, and to input and output the demodulated and modulated information. The aforementioned devices are connected to a system bus 221.

An image bus interface (image bus I/F) 212 is a bus bridge which connects the system bus 221 and an image bus 222 which transfers image data to convert the data structure. The image bus 222 comprises, e.g., a PCI bus or IEEE 1394.

The following devices are connected to the image bus 222. A raster image processor (RIP) 213 interprets PDL code data to rasterize it to a bitmap image. A device I/F 214 connects, to the controller unit 204, the scanner unit 201 and the printer unit 202 as the image input and output devices via signal lines 223 and 224, respectively, and performs conversion between a synchronous system and an asynchronous system of image data. A scanner image processor 215 corrects, modifies, and edits input image data. A printer image processor 216 performs correction, resolution conversion, and the like according to the performance of the printer unit 202 to print output image data to be output to the printer unit 202. An image rotation unit 217 rotates input image data, and outputs the rotated image data. An image compression unit 218 applies JPEG compression/decompression processing or compression/expansion processing unique to a device to multi-valued image data, and compression/decompression processing of JBIG, MMR, or MH to binary image data.

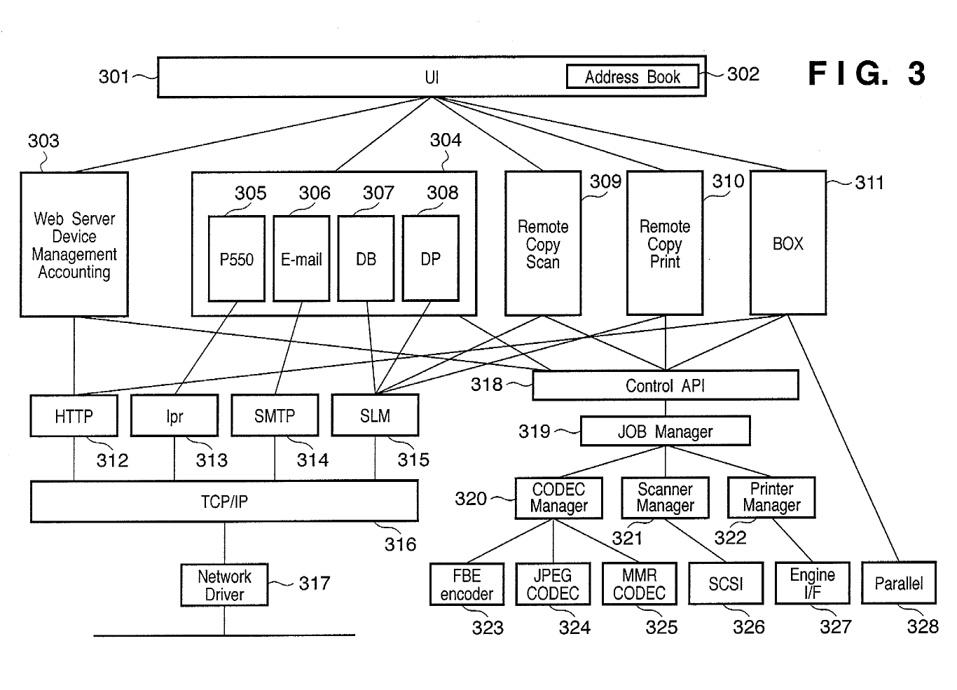

FIG. 3 is a block diagram showing functional arrangement of the software to be implemented in the controller unit of the MFP according to the first embodiment.

Reference numeral 301 denotes a user interface (to be abbreviated as UI hereinafter), which is a module that serves as an intermediary between devices and user's operations when the operator makes various kinds of operations and settings for the MFP using the operation unit 203. This module transfers input information to various modules to be described later in accordance with the operations of the operator, and requests these modules to execute corresponding processes or sets data in these modules.

Reference numeral 302 denotes an address book, i.e., a database module which manages sending destinations, communication destinations, and the like of data. As for the contents of the address book 302, operations from the operation unit 203 are detected by the UI 301 to add, delete, and acquire data, and the address book 302 is used to give sending or communication destination information to respective modules to be described later in response to the operations of the operator.

Reference numeral 303 denotes a Web server module which is used to notify management information of this MFP in response to a request from a Web client. This management information is read by a universal-send module 304 and remote-copy-scan module 309 (to be described later). Also, the management information is read via a remote-copy-print module 310 and control-API 318 (to be described later). The Web client is notified of the management information via an HTTP module 312, TCP/IP module 316r and network driver 317 (to be described later). The Web server module 303 crates information to be passed to the Web client as data of a so-called Web page format such as an HTML format or the like. The Web server module 303 uses Java™, a CGI program, and the like as needed.

Reference numeral 304 denotes a universal-send module, i.e., a module which controls delivery of data. The universal-send module 304 delivers data designated by the operator via the UT 301 to a designated communication (output) destination. When the operator instructs to generate delivery data using the scanner function of this MFP, the universal-send module 304 generates data by operating the scanner unit 201 of this MFP via the control-API 318 to be described later.

Reference numeral 305 denotes a module which is executed when a printer is designated as an output destination in the universal-send module 304. Reference numeral 306 denotes a module executed when an e-mail address is designated as a communication destination in the universal-send module 304. Reference numeral 307 denotes a module executed when a database is designated as an output destination in the universal-send module 304. Reference numeral 308 denotes a module executed when an MFP similar to this MFP is designated as an output destination in the universal-send module 304.

Reference numeral 309 denotes a remote-copy-scan module. The remote-copy-scan module 309 outputs image information read by the scanner unit 201 using the scanner function of the MFP 101 using, as an output destination, a printer of another MFP connected via a network or the like, and executes processing equivalent to the copy function implemented by the MFP 101 alone.

Reference numeral 310 denotes a remote-copy-print module. This module outputs image information, which is read by a scanner of another MFP as an input source connected via a network or the like, using the printer function of the MFP 101. In this way, the remote-copy-print module 310 similarly executes the processing equivalent to the copy function implemented by the MFP 101 alone.

A BOX module 311 stores a scan image or PDL print image in an HDD (storage unit). The BOX module 311 prints the stored image using the printer function or sends the stored image using the universal-send function. The BOX module 311 provides a management function such as deletion, grouping (storage in each individual BOX), inter-BOX movement, inter-BOX copying, and the like of documents stored in the HDD. Note that the communication function of the BOX module 311 is provided by the HTTP module 312 and TCP/IP module 316.

Reference numeral 312 denotes an HTTP module which is used when the MFP makes communications using the HTTP. The HTTP module 312 provides a communication function to the Web server module 303 and Web pull-print module (BOX) 311 described above together with the TCP/IP module 316 to be described later. Reference numeral 313 denotes an Ipr module which provides a communication function to the printer module 305 in the aforementioned universal-send module 304 together with the TCP/IP module 316 to be described later. Reference numeral 314 denotes an SMTP module which provides a communication function to the e-mail module 306 in the aforementioned universal-send module 304 together with the TCP/IP module 316 to be described later. Reference numeral 315 denotes an SLM module, i.e., a salutation-manager module. This module provides a communication function to the database module 307 and DP module 308 together with the TCP/IP module 316 to be described later. Furthermore, the SLM module 315 provides a communication function to the remote-copy-scan module 309 and remote-copy-print module 310.

Reference numeral 316 denotes a TCP/IP module, which provides a network communication function to various modules described above using the network driver 317 to be described below. Reference numeral 317 denotes a network driver, which controls units physically connected to the network.

Reference numeral 318 denotes a control-API, which provides an interface with downstream modules such as a job-manager 319 and the like to upstream modules such as the universal-send module 304 and the like. In this manner, the control-API 318 reduces the dependence between the upstream and downstream modules to make them more versatile. Reference numeral 319 denotes a job-manager. The job-manager 319 interprets processes designated from the aforementioned modules via the control-API 318, and issues instructions to respective modules to be described later. The job-manager 319 unifies management of various jobs to be executed in this MFP as well as control of FAX jobs.

Reference numeral 320 denotes a CODEC-manager. The CODEC-manager 320 manages and controls various kinds of compression and decompression of data of the processes designated by the job-manager 319. Reference numeral 323 denotes an FBE-encoder module. The FBE-encoder module 323 compresses data read by the scan processing executed by a scan-manager 321 (to be described later) in an FBE format. Reference numeral 324 denotes a JPEG-CODEC module. The JPEG-CODEC module 324 is used in the scan processing executed by the job-manager 319 and scan-manager 321 and the print processing executed by a print-manager 322. More specifically, the JPEG-CODEC module 324 executes JPEG compression processing of the read data, and JPEG decompression processing of print data. Reference numeral 325 denotes an MMR-CODEC. The MMR-CODEC 325 is used in the scan processing executed by the job-manager 319 and scan-manager 321, and the print processing executed by the print-manager 322. More specifically, the MMR-CODEC 325 executes MMR compression processing of data read by the scanner, and MMR decompression processing of print data to be output to the printer.

Reference numeral 321 denotes a scan-manager, which manages and controls the scan processing designated by the job-manager 319. Reference numeral 326 denotes a SCSI driver, which communicates with scan-manager 321 and the scanner unit 201, which is internally connected to the MFP. Reference numeral 322 denotes a print-manager, which manages and controls the print processing designated by the job-manager 319. Reference numeral 327 denotes an engine-I/F, which provides an I/F between the print-manager 322 and the printer unit 202. Reference numeral 328 denotes a parallel port driver, which provides an I/F used when the Web pull-print module (BOX) 311 outputs data to an output device (not shown) via a parallel port.

Details of the address book 302 will be described below. The address book 302 is saved in a nonvolatile storage device (such as a nonvolatile memory, hard disk, or the like), and describes features of other devices connected to the network. For example, the address book 302 includes features listed below.
Formal or alias names of devices
Network addresses of devices
Network protocols that devices can process
Document formats that devices can process
Compression types that devices can process
Image resolutions that devices can process
Available paper sizes and feed deck information in case of printer devices
Folder names that can store documents in case of server (computer) devices

With reference to the address book 302, the MFP 101 can send data. For example, a remote-copy application determines resolution information that a device designated as a delivery destination can process with reference to the address book 302. The remote-copy application compresses a binary image read by the scanner using known MMR compression in accordance with the determination result. For example, the remote-copy application generates a known TIFF (Tagged Image File Format) image, and sends it to a printer device on the network via the SLM 315. The SLM (salutation-manager) 315 is one type of network protocols including device control information and the like.

<Operation of Apparatus>

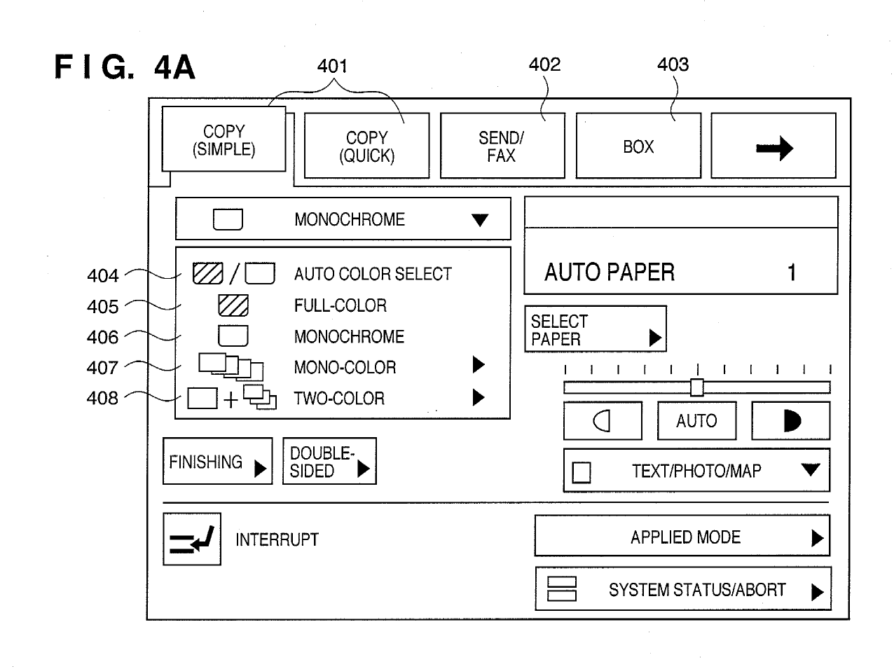

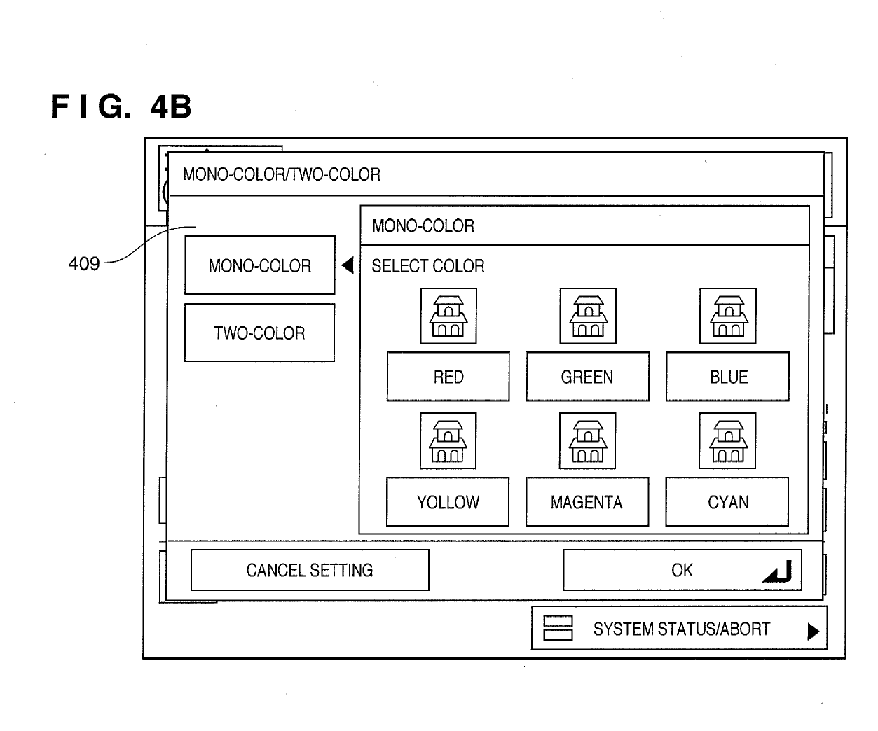

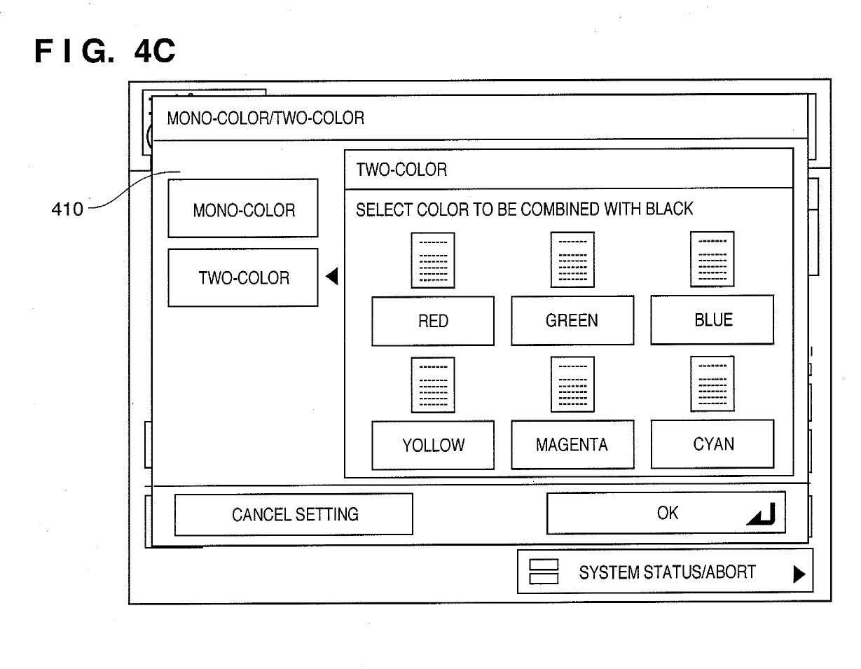

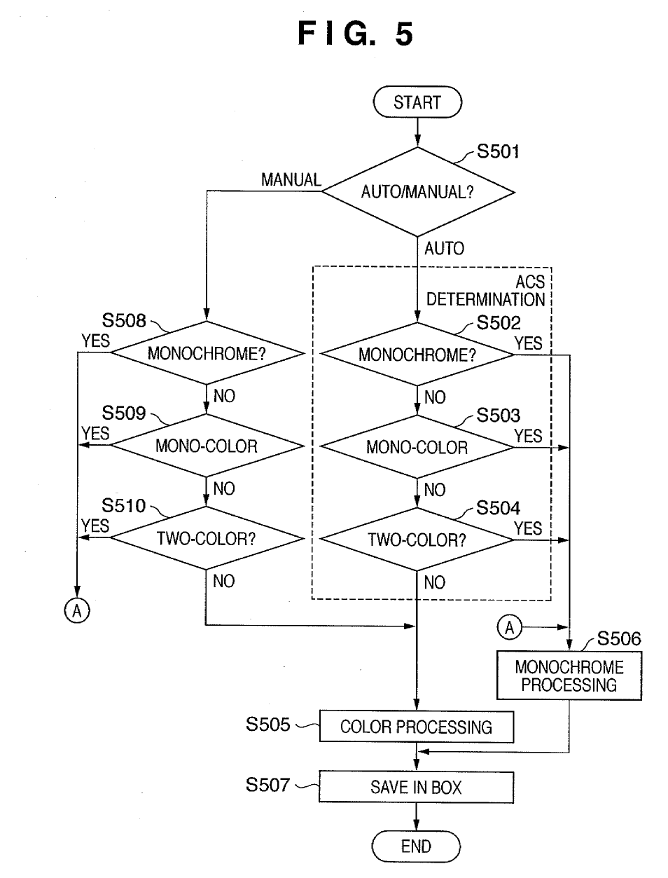

The sequence from when the originals 102 to 105 are read by the scanner of the MFP 101 until the monochrome image data 107 and additional information 108 are stored in the BOX 106 will be described below with reference to FIGS. 4A to 4C and FIG. 5.

FIGS. 4A to 4C show an example of user interface (UI) windows of the MFP according to the first embodiment. Each UI window is displayed on the operation unit 203, which comprises a touch panel display in this example.

The user designates menus 401 to 403 shown in FIG. 4A when he or she wants to copy, send, and store, in the BOX, a read original. The user designates colors used in printing using menus 404 to 408.

When “auto color select” 404 is selected, the user need not consider colors used in an original, and the MFP automatically recognizes the colors. If the number of colors used in an original is three or more, and full-color image data is recognized, the MFP executes full-color printing. If a monochrome image defined by an achromatic color alone is determined, the MFP executes monochrome printing.

The user can manually select “full-color” 405, “monochrome” 406, “mono-color” 407, and “two-color” 408. FIGS. 4B and 4C show UI windows when the user manually selects “mono-color” and “two-color”. Upon selection of “mono-color”, the user can set in advance a color upon printing as the “mono-color” from red, green, blue, yellow, magenta, cyan, and the like, as shown in a window 409. Upon selection of “two-color”, the user can set in advance a color upon printing as a mono color to be combined with black from red, green, blue, yellow, magenta, cyan, and the like, as shown in a window 410. For example, when the user designates red on the “mono-color” designation window, an image is printed out using red ink/toner alone.

FIG. 5 is a flowchart executed when the MFP makes color determination of an original and stores image data in the BOX according to the first embodiment.

A UI operation will be briefly described first. The user places an original on a platen of the MFP, and selects the copy menu 401 or BOX menu 403. Upon selection of the copy menu 401, a copy of the read original is output, and its image data is stored in the BOX. On the other hand, upon selection of the BOX menu 403, only storage of image data in the BOX is executed.

Then, the user selects “auto color select” 404 or one of manual color selections, i.e., “full-color” 405, “monochrome” 406, “mono-color” 407, and “two-color” 408. After that, when the user places an original on the platen of the MFP 101, and presses a start button (not shown) on the operation unit 203, an original image is read (input) by the scanner unit 201. Note that the controller unit 204 of the MFP 101 executes the following steps.

The controller unit 204 checks in step S501 if the user selects an auto or manual color mode. If the user selects “auto color select” 404, the controller unit 204 executes steps S502 to S504 to determine the type of original. Note that this processing (ACS determination) will be described in detail later. If the user selects one of “full-color” 405, “monochrome” 406, “mono-color” 407, and “two-color” 408, the controller unit 204 determines a color or colors selected by the user in steps S508 to S510.

If a “color (full-color)” original is determined based on the color selection result, the process advances to step S505 to execute full-color processing of image data read by the scanner unit 201 (to be referred to as read image data hereinafter). On the other hand, if a “monochrome”, “mono-color”, or “two-color” original is determined, the process advances to step S506 to execute monochrome processing of the read image data.

In step S507, the controller unit 204 saves full-color image data generated in step S505 or monochrome image data generated in step S506 in the BOX.

<Details of Operation>

[ACS Determination]

As described above, if the user selects “auto color select” in step S501, the controller unit 204 checks data in steps S502 to S504 to determine if the read image data is monochrome, mono-color, or two-color image data. Note that this determination processing will be referred to as Auto Color Select (ACS) determination hereinafter.

The controller unit 204 checks in step S502 if the read image data is monochrome image data. If the read image data is defined by an achromatic color alone, the unit 204 determines a monochrome image, and the process advances to step S506. If the read image data includes a chromatic color, it determines an image other than a monochrome image, and the process advances to step S503.

The controller unit 204 checks in step S503 if the read image data is two-color image data. If the read image data is defined by two colors, i.e., one chromatic color and white, the unit 204 determines a mono-color image, and the process advances to step S506; otherwise, the process advances to step S504.

The controller unit 204 checks in step S504 if the read image data is two-color image data. If the read image data is defined by two colors, i.e., one chromatic color and black, the unit 204 determines a two-color image, and the process advances to step S506. If the read image data includes three or more chromatic colors, the unit 204 determines a full-color image, and the process advances to step S505.

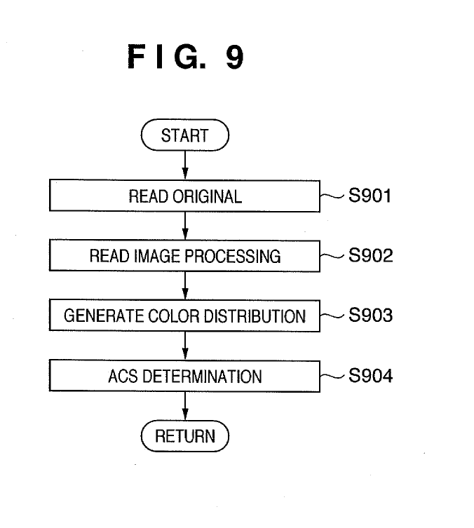

The ACS determination will be described in more detail below with reference to FIGS. 9 to 12.

FIG. 9 is a flowchart showing an example of the processing sequence upon ACS determination of the read image data.

In step S901, the scanner unit 201 reads an original image and generates read image data.

In step S902, the controller unit 204 executes image processes unique to a scanner image, e.g., various filter processes, gamma conversion, and color space conversion, for the read image data generated in step S901.

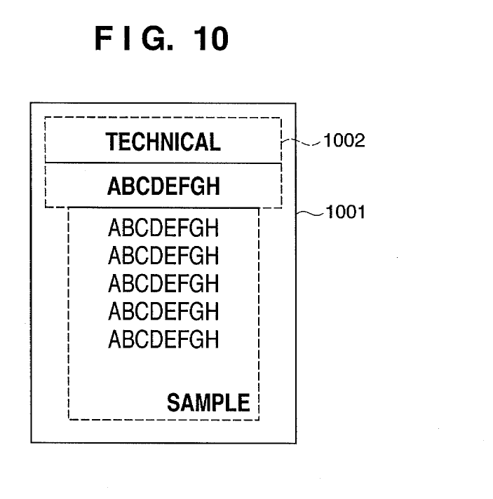

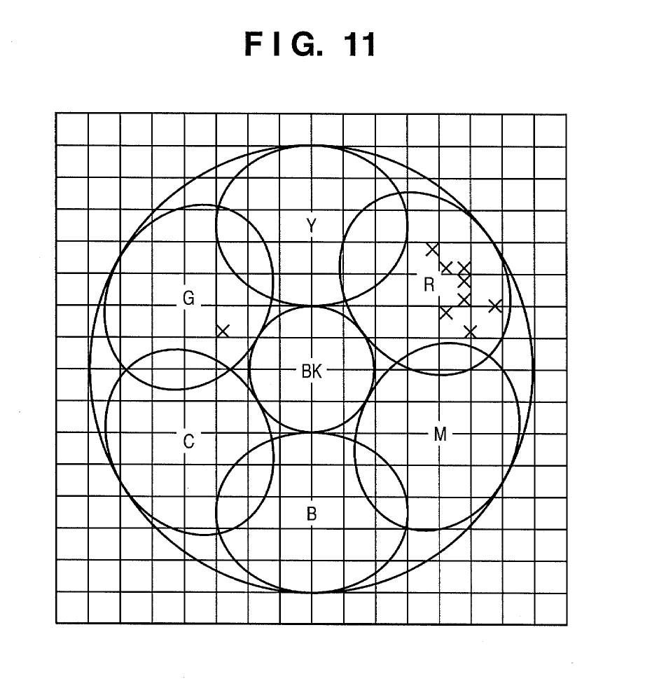

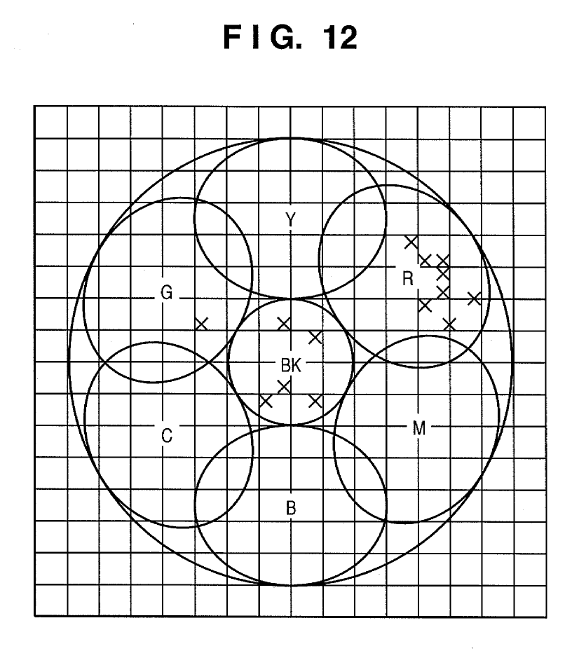

In step S903, the controller unit 204 derives a color distribution of the read image data processed in step S902. FIG. 10 shows an example of an original. FIGS. 11 and 12 show examples of the color distributions to be derived. Referring to FIGS. 11 and 12, symbol “x” indicates the corresponding positions of colors corresponding to respective pixels. FIGS. 11 and 12 show the color distributions using “hue” and “brightness” as references, but other amounts (color differences, saturation, and the like) associated with colors may be used.

In step S904, the controller unit 204 executes ACS determination (image type determination) based on the color distribution derived in step S903.

ACS Mono-Color Determination

FIG. 11 shows an example of the color distribution generated in step 5503 when both regions 1001 and 1002 shown in FIG. 10 are red. In the ACS determination, the distribution state of all regions shown in FIG. 11 is confirmed. Based on the confirmation result, the order of frequencies of occurrence of colors included in the read image data is determined. In the color distribution shown in FIG. 11, the frequencies of occurrence of colors are concentrated at the positions of “R”. The distribution state is confirmed for other positions, but the frequencies of occurrence at other positions are extremely smaller than those at the positions of “R”. For this reason, the frequencies of occurrences at positions other than “R” are ignored since they are determined as noise on the original. For this reason, in the color distribution shown in FIG. 11, “R” ranks first (representative color) in the order of colors, and other colors are ignored. That is, it is determined that the original is defined by red alone (i.e., mono-color image data).

ACS Two-Color Determination

FIG. 12 shows an example of the color distribution generated in step S503 when a region 1001 is red and a region 1002 is black in FIG. 10. In this case, the frequencies of occurrence of colors are concentrated at positions of “R” and “BK” in FIG. 12. The distribution state is confirmed for other positions. However, when the frequencies of occurrence of other positions are extremely smaller than those of “R” and “BK”, they are determined as noise on the original and are ignored. Based on this result, the “R” ranks first (representative color) and “BK” ranks second in the order of colors, and other colors are ignored. That is, it is determined that the original is defined by two colors, e.g., red and black (i.e., two-color image data).

ACS Monochrome Determination

In the description of the aforementioned ACS mono-color determination, when “BK” ranks first and other colors are ignored, monochrome image data is determined.

[Monochrome Processing]

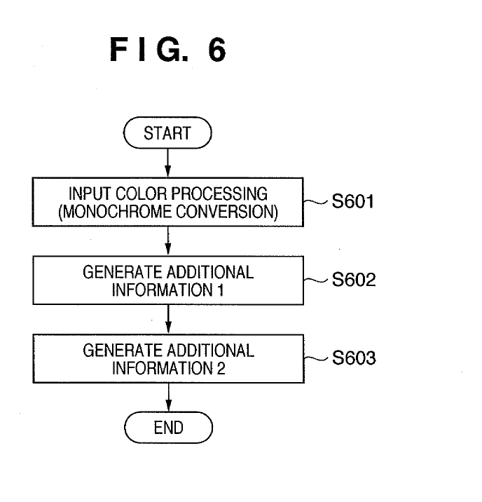

FIG. 6 is a flowchart showing the operation associated with the monochrome processing in step S506. The monochrome processing is executed when it is determined that the user selects one of “monochrome” 406, “mono-color” 407, and “two-color” 408 in the manual color selection. Also, the monochrome processing is executed when one of “monochrome”, “mono-color”, and “two-color” is determined in the ACS determination. Note that the controller unit 204 of the MFP 101 executes the following steps.

In step S601, the controller unit 204 applies monochrome conversion to the read image data. More specifically, the unit 204 converts the read image data (24 bits (8 bits/R, G, and B)/pixel) read by the scanner into monochrome image data (1 bit/pixel; binary image data) (to generate binary image data). Note that the unit 204 may convert the read image data into multi-valued image data such as grayscale image data (8 bits/pixel), as will be described later. A case will be described below wherein the read image data is converted into monochrome image data. As for conversion into monochrome image data itself, known arbitrary methods can be used. However, this embodiment is different from such methods in that additional information to be described below is generated.

In step S602, the controller unit 204 generates additional information (additional data) 1 (to generate additional data). Additional information 1 is chromatic/achromatic color information for the monochrome image data generated in step S601. That is, additional information 1 is information of 1 bit/pixel assigned to each of all pixels of the monochrome image data. If the value of additional information 1 is “1”, it indicates a chromatic color; if it is “0”, it indicates an achromatic color.

In step S603, the controller unit 204 generates additional information 2. Additional information 2 includes attribute information indicating that the original is one of “monochrome”, “mono-color”, and “two-color”, and color information corresponding to the monochrome image data generated in step S601. If the value of the attribute information is “0”, the original is “monochrome”; if it is “1”, the original is “mono-color”, and if it is “2”, the original is “two-color”. As the color information, in case of “auto color select”, the representative color or colors extracted in steps S503 and S504 are set. In case of the manual color selection, a color or colors designated on the setting window shown in FIG. 4B or 4C are set.

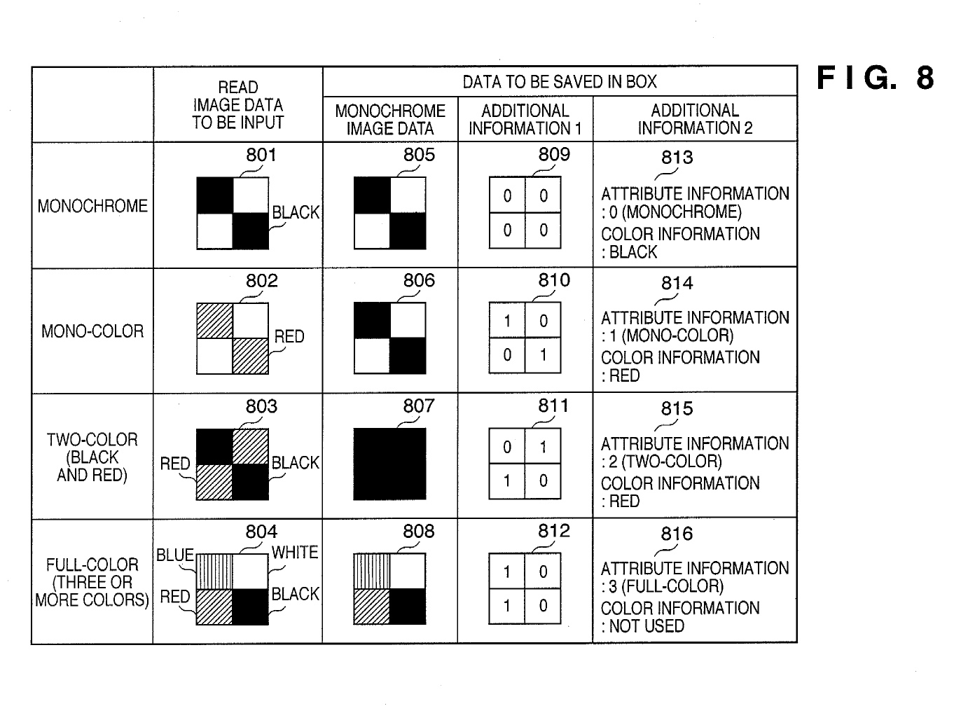

FIG. 8 shows examples of data generated by the monochrome processing and full-color processing. FIG. 8 shows data for only 2×2 pixels of an image for the sake of simplicity.

Referring to FIG. 8, reference numerals 801 to 804 denote read image data (24 bits (8 bits/R, G, and B)/pixel). Reference numerals 805 to 807 denote monochrome image data (1 bit/pixel) after the monochrome processing; and 808, color data (24 bits (8 bits/R, G, and B)/pixel) after the color processing. Reference numerals 809 to 812 denote additional information 1 (chromatic/achromatic color information); and 813 to 816, additional information 2 (attribute information and dolor information).

For example, the monochrome image 802 is converted by the monochrome processing into the 1-bit monochrome image data 806. As additional information 1, the data 810 is generated since red pixels of the data 806 are determined as a chromatic color, and other pixels are determined as an achromatic color. Also, as additional information 2, the data 814 which indicates attribute information 1 (mono-color) and color information=red is generated.

The controller unit 204 saves the monochrome image data, additional information 1 (chromatic/achromatic color information), and additional information 2 (attribute information and color information) in the BOX in step S507. When these data are compressed by known lossless compression (e.g., MMR compression, ZIP compression, or the like), the data storage efficiency in the BOX area can be improved. In this case, data of three types to be generated are described separately, but they may be saved as a single file. For example, the two pieces of additional information may be appended to the header of the monochrome image data. In the color processing in step S505, data is generally compressed by JPEG, and the compressed data is stored in the BOX in step S507.

In this manner, an original which is one of “monochrome”, “mono-color”, and “two-color” can be read by the scanner of the MFP 101, and can be stored in the BOX 106 as the monochrome image data 107, additional information 1, and additional information 2. In this case, the image read by the scanner unit 202 has been described. Alternatively, the same processing may be applied to image data (PDL data or the like) which is sent from a host computer connected to the network to the MFP 101.

<Output Monochrome Image Data>

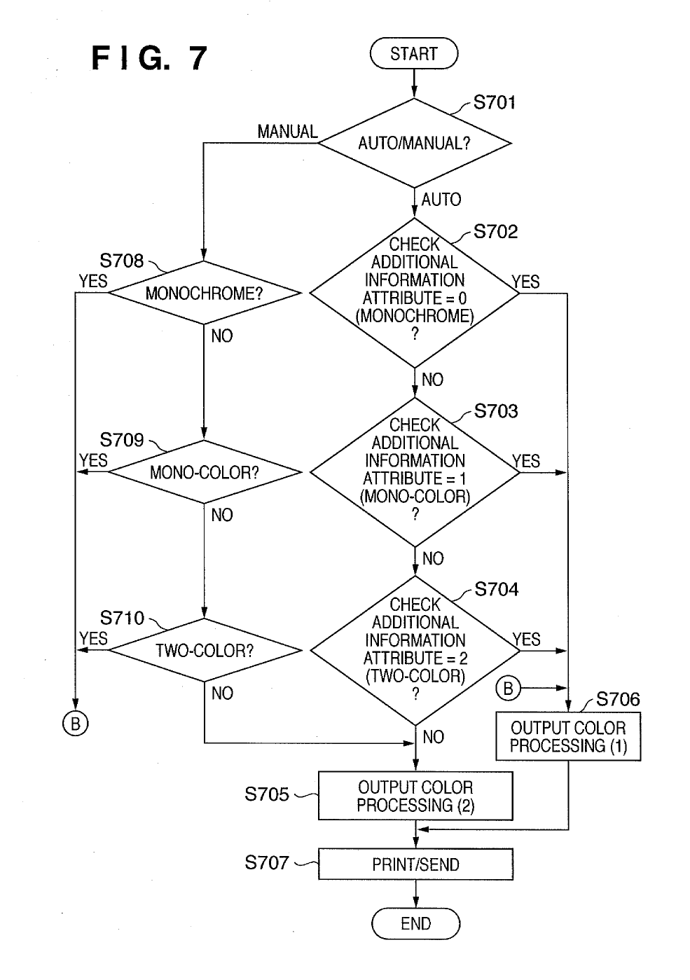

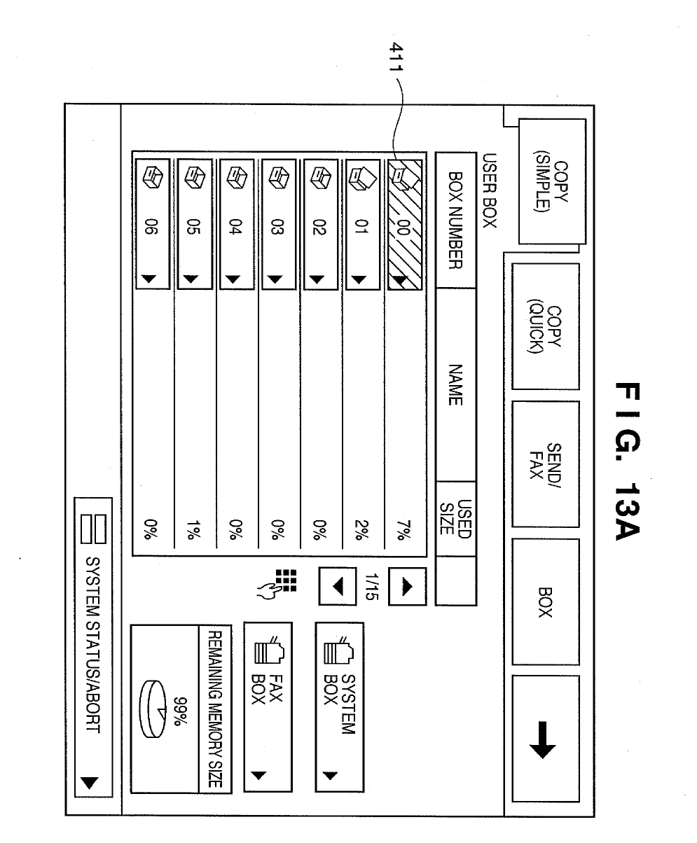

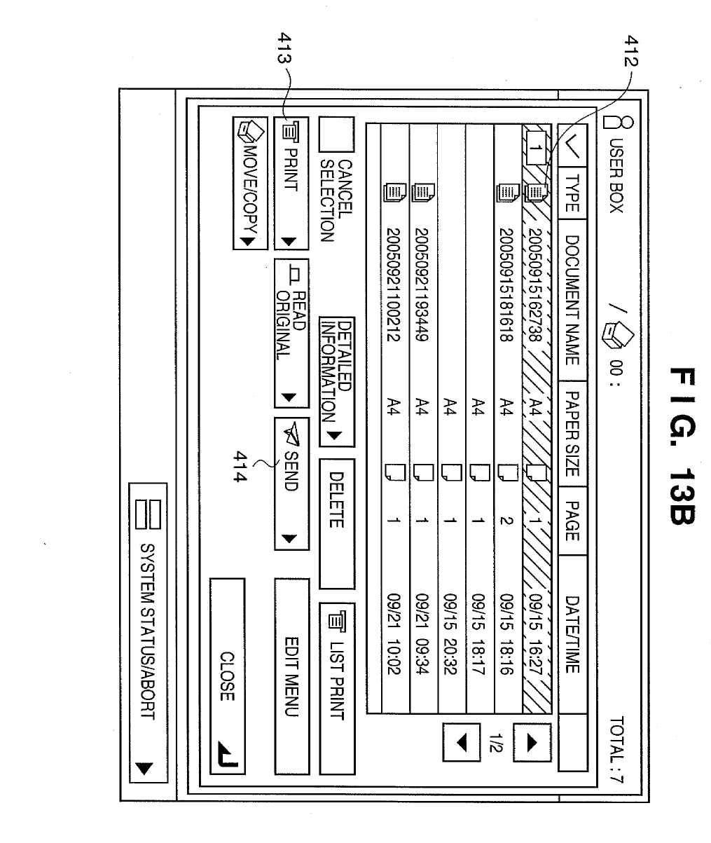

FIG. 7 is a flowchart upon outputting (printing or sending) the monochrome image data saved in the BOX. FIGS. 13A and 13B show examples of setting windows upon selection of the BOX menu.

When the user selects the BOX menu 403, the window shown in FIG. 13A is displayed. On this window, the user designates a button 411 corresponding to BOX number “00” that stores a desired image. Then, the window shown in FIG. 13B corresponding to BOX number “00” is displayed. The user selects a desired image 412, and presses a print button 413 if he or she wants to print that image or a send button 414 if he or she wants to send that image.

In step S701, user's auto or manual color selection is accepted. The user selects “auto color select” 404 or one of “full-color” 405, “monochrome” 406, “mono-color” 407, and “two-color” 408. The menus 404 to 408 in FIG. 4A are those on the window of the copy menu 401, but assume that similar menus are also displayed on the window of the BOX menu 403. Upon selection of “auto color select”, the process advances to step S702. Upon selection of one of “full-color”, “monochrome”, “mono-color”, and “two-color”, the process advances to step S708. As for manual output processes (steps S708 to S710), the user manually designates a color upon outputting (printing or sending) monochrome image data. That is, the user forcibly designates a color regardless of the information stored in the additional information. However, since these processes are nearly the same as the conventional method a description thereof will not be given.

In steps S702 to S704, the MFP 101 executes color reproduction processing of the monochrome image data using additional information 1 and additional information 2 stored in the BOX. In steps S702 to S704, it is checked based on additional information 2 if the monochrome image data designated to be output is “monochrome”, “mono-color”, or “two-color”.

If it is determined that the designated monochrome image data is “monochrome”, “mono-color”, or “two-color”, the process advances to step S706. On the other hand, if it is determined that the designated monochrome image data is none of “monochrome”, “mono-color”, and “two-color”, “full-color” is determined, and the process advances to step S705. In step S705, known full-color data processing is executed as output color processing (2).

In step S706, output color processing (1) is executed. More specifically, the designated monochrome image data is converted into image data corresponding to one of “monochrome”, “mono-color”, and “two-color” based on additional information 1 and the color information stored in additional information 2. The color reproduction processing means processing for assigning (substituting) color information using color information 2 to a chromatic color pixel, or color information of white or black to an achromatic color pixel. The output color processing (1) includes color processing from an RGB color space into a printer device color space, color conversion from the RGB color space into a monitor RGB color space, and the like. That is, the output color processing includes minimum required output image processes to print or send the data.

Upon sending the data, it is a common practice to execute resolution conversion processing and compression processing in step S705, S706, or S707.

As described above, upon execution of the image processing by the MFP according to the first embodiment, image data can be stored in the BOX in a color reproducible format while reducing the data size.

When an original is “full-color” data, the user stores monochrome image data in the BOX together with a chromatic/achromatic flag. When the user wants to print data using two colors, a chromatic/achromatic flag is used, a color designated by the UI is used for a chromatic part, and black is used for an achromatic part. On the other hand, if an original is “two-color” or “mono-color” data, the original is read to store grayscale image data in the BOX, and chromatic/achromatic determination flag and color component data are also stored. Upon printing or sending the stored data, the color of the color component data is used for a chromatic part and black is used for an achromatic part based on the chromatic/achromatic flag to implement “two-color” or “mono-color” output processing.

For example, upon reading an original with an A4 paper size at 600 dpi, its full-color data has a size of about 100 Mbytes, and that data is compressed to several 10 Mbytes. In general, since lossy compression such as JPEG or the like is used, image deterioration occurs. By contrast, in the method described in the first embodiment, only monochrome image data (about 4 Mbytes)+additional information 1 (about 4 Mbytes)+additional information 2 (several bytes) are required. Since these data can be compressed to several Mbytes to 8 Mbytes normally using lossless compression, no image deterioration occurs.

(Modification)

In the first embodiment, additional information 1 (chromatic/achromatic color information) to be stored in the BOX expresses each pixel by 1-bit data. However, each pixel may be expressed by data of 2 bits or more (N-bit value: N is a natural number equal to or larger than 2). In this case, colors can be reproduced as image data of four or more colors. More specifically, if each pixel is expressed by 2 bits, four different pieces of information, i.e., chromatic colors 1 to 3 and an achromatic color are extracted upon reading an original, and are stored as additional information 1. Also, three pieces of color information 1 to 3 are stored as that of additional information 2. In this way, four colors can be reproduced.

### Other Embodiments

The preferred embodiments of the present invention have been explained, and the present invention may be applied to either a system constituted by a plurality of devices, or an apparatus consisting of a single device.

Note that the present invention can also be achieved by directly or remotely supplying a program that implements the functions of the aforementioned embodiments to a system or apparatus, and reading out and executing the supplied program code by that system or apparatus. Therefore, the technical scope of the present invention also includes the program code itself to be installed in a computer so as to make computer implement the functional processing of the present invention.

In this case, the form of program is not particularly limited, and an object code, a program to be executed by an interpreter, script data to be supplied to an OS, and the like may be used as long as they have the program function.

As a recording medium for supplying the program, for example, a floppy® disk, hard disk, optical disk (CD, DVD), magneto-optical disk, magnetic tape, nonvolatile memory card, ROM, and the like may be used.

As another program supply method, the program can be supplied when the user establishes a connection to a home page on the Internet using a browser of a client computer and downloads the computer program itself according to the present invention from the home page. Also, the program can be supplied when the user downloads a compressed file that includes an automatic installation function to a recording medium such as a hard disk or the like. Also, the program code that forms the program of the present invention may be segmented into a plurality of files, which may be downloaded from different home pages. That is, the scope of the present invention includes a WWW server which makes a plurality of users download a program required to implement the functional processes of the present invention by the computer.

Furthermore, a storage medium such as a CD-RON or the like, which stores the encrypted program of the present invention, may be delivered to the users. The user who has cleared a predetermined condition may be allowed to download key information that decrypts the program from a home page via the Internet, and the encrypted program may be executed using that key information to be installed on a computer, thus implementing the present invention.

The functions of the aforementioned embodiments can be implemented when the computer executes the readout program. In addition, an OS, which runs on the computer, executes some or all of actual processes based on an instruction of the program, thereby implementing the functions of the aforementioned embodiments.

Furthermore, the program read out from the recording medium is written in a memory of an expansion board or a function expansion unit, which is inserted in or connected to the computer. After that, a CPU or the like equipped on that function expansion board or unit executes some or all of actual processes, thereby implementing the functions of the aforementioned embodiments.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-077158, filed Mar. 23, 2007, which is hereby incorporated by reference herein in its entirety.

What is claimed is:

1. An image processing apparatus comprising:
an image input unit adapted to input image data by reading an original image;
a determination unit adapted to determine a representative color included in the image data;
a binary image data generation unit adapted to generate binary image data including no color information based on the image data;
an additional data generation unit adapted to generate additional data as color information corresponding to each pixel which forms the binary image data based on the representative color determined by said determination unit; and
a storage unit adapted to store the binary image data and the additional data.

2. The apparatus according to claim 1, further comprising a two-color image generation unit adapted to generate a two-color image including color information based on the binary image data and the additional data.

3. The apparatus according to claim 1, further comprising an operation unit adapted to accept an instruction input from a user,
wherein said determination unit determines the representative color based on the instruction input of the user from said operation unit.

4. The apparatus according to claim 1, wherein said determination unit determines the representative color based on a color distribution of pixels which form the image data.

5. The apparatus according to claim 1, wherein said determination unit comprises an image type determination unit adapted to determine one of image types including monochrome binary image data defined by an achromatic color alone, mono-color image data defined by only one achromatic color or white and one chromatic color, and two-color image data defined by black and one chromatic color, and
said additional data generation unit generates additional data including the image type determined by said image type determination unit and color information corresponding to each of two values of the binary image data.

6. An image processing apparatus comprising:
an image input unit adapted to input image data by reading an original image;
a determination unit adapted to determine a representative color included in the image data;
a data generation unit adapted to generate data, which includes no color information, and each pixel of which is expressed by an N-bit value (N is a natural number), based on the image data;
an additional data generation unit adapted to generate additional data as color information corresponding to each pixel which forms data expressed by the N-bit value based on the representative color determined by said determination unit; and
a storage unit adapted to store the data expressed by the N-bit value and the additional data.

7. A method of controlling an image processing apparatus, comprising:
an image input step of inputting image data by reading an original image;
a determination step of determining a representative color included in the image data;
a binary image data generation step of generating binary image data including no color information based on the image data;
an additional data generation step of generating additional data as color information corresponding to each pixel which forms the binary image data based on the representative color determined in the determination step; and
a storage control step of storing the binary image data and the additional data in a storage unit.
